(19) United States
(12) Patent Application Publication
(10) Pub. No.: US 2009/0224921 A1
(43) Pub. Date: Sep. 10, 2009

(54) Safety scan

(76) Inventor: Charotte C. Janzen, Wichita, KS (US)

Correspondence Address: William J. Miller;Miller Law Office, P.O. Box 547, Ponca City, OK, 74602, US

(21) Appl. No.: 12/381,094

(22) Filed: Mar. 7, 2009

Related U.S. Application Data
(60) Provisional application No. 61/125,199, filed on Mar. 10, 2008.

(51) Int. Cl. G08B 13/14

(52) U.S. Cl. 340/572.1

(57) ABSTRACT

This invention describes a method for protection a person, child or adult who is not responsible for their actions consisting of attaching a triggering device to said person as they enter the establishment while the Guardian or mother, for example, is shopping. If the person decides to wander off. In that case, the person will bi-pass the security system, triggering the alarm and causing the clerk in charge of the door to stop said person from leaving.

This application is being filed from a provisional application dated Mar. 10, 2008 with provisional application No. 61/125,199, titled SAFETY SCAN.

### PRIOR ART

The best known prior art to Applicant is the use of a merchandise protection device used in stores to keep persons from stealing merchandise from the store without paying. The device is usually attached to the merchandise by a tool which locks the device onto the merchandise such as a dress or a blouse. A security loop is placed at the exit to the store. If a person tries to exit without removing the device, an alarm will sound alerting the store personnel of the theft. Other devices are placed on merchandise by sticking the unit onto the package. As the package is scanned, a unit demagnitizes the device allowing the package to exit without imitating the alarm. These units are in wide use today.

### SUBJECT OF THIS INVENTION

This invention uses a novel use of the merchandise protection device. One of the big problems with adults shopping today is escaping children or adults with dementia such as Alzheimers who leave the store unknown to their parents or guardians. In large shopping malls, a child or adult can be kidnapped or lost for a long period of time, particularly if the adult is unaware that the person is missing. A person with dementia tend to walk off without any warning to the ward. Even a few minutes can at times, be disastrous. Our invention relates to a method for attaching a merchandise protection device to a child or adult (person) as they enter the store. If the person attempts to leave, the security system will set of the alarm system and a store personnel will immediately stop the person from leaving and announce over the store public address system that the parent or ward should return to the checkout counter and rescue the person leaving. It would be preferable to have a name tag attached to the person for identification purposes, particularly if the person is too young to know their name or the adult cannot know his or her name.

### BRIEF DESCRIPTION OF THE FIGURES

FIG. 1 shows the attachment of the merchandise protection device to the lapel or other clothes of a person; and

FIG. 2 shows the method of using the merchandise protection device in a store or other location;

### DETAILED DESCRIPTION OF THE INVENTION

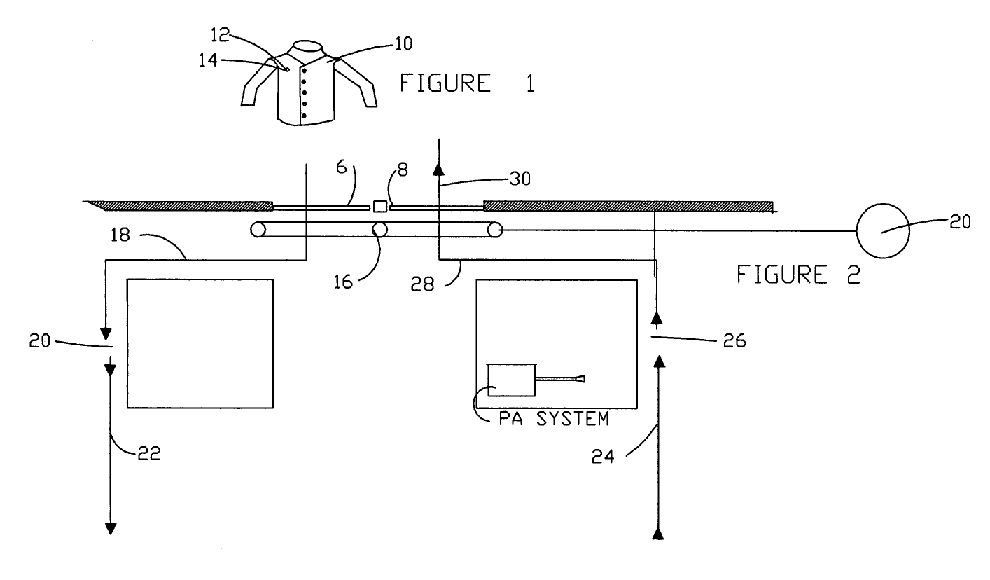

Referring to FIG. 1, an item of clothing 10, has a triggering device 12 attached thereto at 14 at the time the person such as a person enters the store or establishment.

Referring to FIG. 2, as the child or other person enters through door 6 and walks along path 18, both the child and the adult and Guardian will have a triggering device mounted on their clothes either in the front as illustrated in FIG. 1. or somewhere, for example the back of the person making it difficult for said person to remove said trigger. The person and their ward will continue in the establishment along arrow 22. If a person decided to explore the outside of the store and wanders along line 24 with or without being in the custody of his or her parent or ward, as for example if he or she should see something of interest outside the exit of the store he may wander toward the exit through door 8, bi-passing the clerk at stopping point 26. As he passes the sensing device 16 it will captures a signal from the triggering device 12 setting off an alarm or other warning device 20 which will notify the clerk that a person is leaving the store unauthorized. The clerk's duty will be to stop the person leaving and use the PA SYSTEM to call the adult or ward in charge of said leaving person to come and retrieve said person. In the event no one responds to said PA notification, the store manager will hold said person until a responsible person is located. Most stores already have a sensing device to prevent theft, they also have a triggering device attached to their merchandise. Stores such as Wal*Mart also have devices stuck to the packages that must be demagnitized in order for the package to pass the sensing devices at the exit of the store. Such stick-on devices will work as well as those attached to clothing.

1. A method of protecting a person from leaving an environment equipped with a security: system at the entrance or exit of the establishment comprising:
a. Placing a merchandise protection device on the clothes of said person,.
b. Releasing said person to walk freely in said establishment,
c. Imitating an alarm if said person attempts to leave through said security system,
c. Stopping said person from leaving said establishment as said person leaves said establishment through said merchandise protection device.

2. A method of preventing a person from leaving an establishment without a warning, comprising;
a. Establishing a security system for a location having a sensing system at the exit of said location,
b. Connecting an alarm system to said sensing system,
c. Having a triggering device which will initiate said sensing system if said triggering device passes through said sensing system,
Whereby when a person passes through said sensing system with said trigger device attached, said sensing system will cause said alarm to sound, warning a store employee to stop or inspect said person leaving said location.
